(19) United States
(12) Patent Application Publication
(10) Pub. No.: US 2015/0269668 A1
(43) Pub. Date: Sep. 24, 2015

(54) VOTING MECHANISM AND MULTI-MODEL FEATURE SELECTION TO AID FOR LOAN RISK PREDICTION

(71) Applicant: Xerox Corporation, Norwalk, CT (US)

(72) Inventors: Alvaro E. Gil, Rochester, NY (US); Edgar A. Bernal, Webster, NY (US); Nathan Gnanasambandam, Victor, NY (US)

(73) Assignee: Xerox Corporation, Norwalk, CT (US)

(21) Appl. No.: 14/221,723

(22) Filed: Mar. 21, 2014

(51) Int. Cl. G06Q 40/02

(52) U.S. Cl. CPC G06Q 40/025

(57) ABSTRACT

Presented are a system, method, and apparatus for loan risk prediction. A computing device receives a plurality of loan account histories containing variables x; a plurality of algorithms then independently selects features from the loan account histories, the selected features being functions of the received variables x; the selected features are then grouped into a first data structure x_{f}; the computing device applies voting algorithm(s) to the selected features to create a second data structure xᵣ; the computing device generates a third data structure x_{I} of interaction terms from the second data structure xᵣ; a fourth data structure is generated, x_{NL}, where x_{NL}=xᵣ∪x_{I} or x∪x_{I}; a model executes that selects significant features from the fourth data structure x_{NL}; and a nonlinear model y=f(X_{NLR}) is generated, the nonlinear model y indicating risk associated with the plurality of loan account histories.

### TECHNICAL FIELD

The invention is related to the field of loan risk assessment and the determination of risk associated with a plurality of loan accounts. The invention is specifically directed towards a system, method, and apparatus for loan risk prediction via utilization of multiple algorithms to independently select features from a plurality of loan account histories X, the plurality of loan account histories containing variables x describing each loan account. The computing device then utilizes one or a plurality of algorithms to independently select features from the plurality of loan account histories, the selected features being functions of the received variables x. The selected features are then the results grouped into a first data structure x_{f}. A voting algorithm or voting algorithms are then applied to the selected features and grouped into a second data structure xᵣ. A third data structure x_{I} of interaction terms is then generated from the second data structure xᵣ. A fourth data structure, x_{NL}, is then defined by the mathematical union xᵣ∪x_{I} or x∪x_{I}, (where x denotes the set of all the original features in X). These data structures are used directly and indirectly to generate further data structures and various models for loan risk prediction.

This application is related to the co-filed U.S. patent application Ser. No. 14/221,944 and U.S. patent application Ser. No. 14/222,099. These patent applications are incorporated in their entirety here.

### BACKGROUND

The personal lending industry, including the lending of student loans, auto loans, commercial loans, and mortgages, as well as other types of personal loans is valued at trillions of dollars in the United States in the twenty-first century. The total value of mortgages outstanding alone in the United States is $10 trillion dollars. The total value of all student loans outstanding in the United States in 2013 is currently between $902 billion and $1 trillion. The sheer volume of this debt leads to a large amount of competition among lenders, trying to extend the greatest number of loans which have a reasonable chance of being repaid with interest. The tendency to over-purchase existing personal loan accounts from other lenders as well as over-lend leads to situations such as presented in the 2009 Financial Crisis in which defaults of large amounts of mortgages and mortgage-backed securities consisting of individual homeowner's mortgages led to the failure of the entire banking industry, and the need for government bailouts to prevent another Great Depression.

Personal loan accounts consist of accounts such as auto loans, home mortgages, personal lines of credit, credit cards, student loans, and similar type of lending arrangements made to individuals. Whether a lender or loan servicer obtains management of personal loan accounts through directly lending, or via assignment of an existing personal loan account, the need to obtain information on loan risks remains. In any event once management of a personal loan account has been obtained it is necessary to continuously monitor the potential for default for the personal loan account itself. Collection services as well require information on the status of loans, and whether collection should be pursued or not or how aggressively to pursue it. Monitoring of loan account status is required to determine whether the personal loan remains an asset valuable enough to remain “on the books” or whether to file a lawsuit against the personal loan holder to collect on the debt, sell the personal loan to another owner loan servicer, or similar extreme recourse.

Accordingly, a need exists for a system, method, and apparatus for loan risk prediction which facilitates assessment of future risk and other statistics regarding a plurality of loan account histories.

### SUMMARY

The present invention is directed towards a system, method, and apparatus for loan risk prediction comprising receiving by a computing device a plurality of loan account histories X containing variables x transmitted from a database; utilizing by the computing device a plurality of algorithms to independently select features from the plurality of loan account histories (in various embodiments, the plurality of algorithms number between two and eight), the selected features being functions of the received variables x; grouping the selected features selected from the plurality of loan account histories into a first data structure x_{f}; applying by the computing device a voting algorithm or voting algorithms to the selected features selected from the plurality of loan account histories and grouping results into a second data structure xᵣ; generating by the computing device a third data structure x_{I} of interaction terms from the second data structure xᵣ; generating by the computing device a fourth data structure x_{NL} where x_{NL} equals xᵣ∪x_{I} or x∪x_{I}. A model then executes selecting significant features from the fourth data structure x_{NL}, and generates a fifth data structure x_{NLR}. The fourth data structure x_{NL} may also be used to form a data structure X_{NL}, by selecting elements of X whose indices are in the fourth data structure x_{NL}. The fifth data structure x_{NLR} may be used to form a data structure X_{NLR} by selecting elements of X whose indices are in x_{NLR}.

A nonlinear model is generated y=f(X_{NLR}) where f is a nonlinear function, the nonlinear model y indicating risk associated with each of the received plurality of loan account histories on a monthly or other periodic basis for a time period into the future.

The plurality of algorithms independently selecting features may select features from the plurality of loan account histories by operating in parallel (i.e., simultaneously) or sequentially (i.e., one after another). The plurality of algorithms may be two or more of the following: (1) an Elastic Net algorithm; (2) a LASSO algorithm; (3) a Stepwise Regression with the RIC Penalty Algorithm; and/or (4) a Multivariate Adaptive Regression Splines Algorithm.

In a further embodiment of the invention the second data structure xᵣ is used by the computing device to create a data structure Xᵣ that is, in turn, used to generate a linear model, the linear model indicating risk associated with each of the received plurality of loan account histories on a periodic basis for a time period into the future. The time period into the future may be one week, one month, two months, six months, or one year. The linear model may be defined by an equation z=g(Xᵣ). The data structure Xᵣ is formed by selecting elements of X whose indices are in xᵣ. This may occur, by example, via selection of elements in the columns of X whose column indices are in xᵣ.

In an embodiment of the invention, the voting algorithm or voting algorithms are applied to the selected features selected from the plurality of loan account histories to create a second data structure xᵣ, and also perform the steps of: (1) selecting variables that appear at least r times in the first data structure x_{f}, (2) selecting variables that appear r times pairwise, and/or (3) selecting variables that appear r times in models that have a certain average accuracy.

In another embodiment of the invention after generating the nonlinear model y, M algorithms are used to independently confirm features in the generated nonlinear model y. M may be an integer between one and eight, and may be one or more of the following: an Elastic Net Algorithm, a LASSO Algorithm, a Stepwise Regression with the RIC Penalty Algorithm, and/or a Multivariate Adaptive Regression Splines Algorithm.

In a further embodiment of the invention, the third data structure x_{I} of interaction terms comprises sets of two elements and sets of three elements.

Finally, in another embodiment of the invention the generated nonlinear model y is stored in a non-transitory computer-readable storage for future use with test data.

All embodiments of the invention must utilize computing devices to process the large amounts of data being considered (i.e. hundreds, thousands, or even millions of loan account histories and including even more variables describing such loan account histories and including even more variables describing such loan account histories), making impractical manual processing of the large amounts of data and allowing for fast scanning and early risk warning for a plurality of loan account histories associated with a large amount of data.

These and other aspects, objectives, features, and advantages of the disclosed technologies will become apparent from the following detailed description of illustrative embodiments thereof, which is to be read in connection with the accompanying drawings.

### BRIEF DESCRIPTION OF THE DRAWINGS

FIG. 1 is a flowchart displaying the process of execution of an embodiment of the invention.

FIG. 2 is a chart showing the results of use of multiple algorithms to independently select features from a plurality of loan account histories in an embodiment of the invention.

FIG. 3 is a bar graph showing the results of application of a voting algorithm to a data structure in an embodiment of the invention.

FIG. 4 is a chart showing training of a nonlinear model in an embodiment of the invention.

### DETAILED DESCRIPTION

Describing now in further detail these exemplary embodiments with reference to the figures as described above, the system, method, and apparatus for Voting Mechanism and Multi-Model Feature Selection to Aid for Loan Risk Prediction, is described below. It should be noted that the drawings are not to scale.

“Homoscedasticity” and “heteroscedasticity” are typically defined within the context of a sequence or a vector of random variables in the field of statistics. A sequence is “homoscedastic” if, even though the variables or vectors are random, they possess approximately the same finite variance. A sequence is “heteroscedastic” if, on the other hand, the variables within a sequence of random variables or vectors possess largely dissimilar variances. Whether a sequence possesses a dissimilar variance or not is determined by comparison to a “heteroscedasticity score threshold.” In the field of statistics, homoscedasticity or heteroscedasticity is tested for using the White test, the Breusch-Pagan test, the Koenker-Basset test, Goldfeld-Quandt test, or any other means presently existing or after-arising. Within the context of this patent application and related patent applications, “homoscedasticity” or “heteroscedasticity” refers to the homoscedasticity or heteroscedasticity of provided sample data, i.e., sample data involving a plurality of loan account histories which are transmitted from a database.

A “loan account” (within the context of this and associated patent applications) and the associated “loan account history” describing the loan account is a record of debt for the lending of money (typically, for a specific purpose such as a payment for school tuition, refinancing a house, purchasing an automobile, etc.). A loan account contains one or more of the following: principal amount, interest rate, terms of repayment, date(s) of repayment, etc. As discussed within this patent application and associated patent applications a loan account and an associated loan account history will exist in a format accessible to a computing device for processing as a spreadsheet, .csv value, matrix (as defined by certain programming languages), an array, a database entry, a linked-list, a tree-structure, other types of computer files or variables (or any other presently existing or after-arising equivalent). Variables tracked include the origination date of the loan, the original amount of the loan, the remaining principle balance to be paid, the date of the monthly payment, the current interest rate, the terms of repayment, number of original monthly payments, number of remaining monthly payments, whether each monthly payment was timely (true/false), number days delinquent of every monthly payment (from 0-integer), credit score of loan account holder at various points in time, etc. In a further embodiment of the invention, variables further include loan status (ls) (current or not), delinquency days (dd), and forbearance months (fm).

A “computing device,” as discussed in the context of this patent application and related patent applications, refers to one or multiple computer processors acting together, a logic device or devices, an embedded system or systems, or any other device or devices allowing for programming and decision making. Multiple computer systems may also be networked together in a local-area network or via the internet to perform the same function. In one embodiment, a computing device may be multiple processors or circuitry performing discrete tasks in communication with each other. The system, method, and apparatus described herein are implemented in various embodiments as, to execute on a “computing device[s],” or, as is commonly known in the art, such a device specially programmed in order to perform a task at hand. A computing device is a necessary element to process the large amount of data (i.e., thousands, tens of thousands, hundreds of thousands, or even more of loan accounts, loan account histories, and associated variables). Furthermore, the present invention may take the form of a computer program product embodied in any tangible medium of expression having computer usable program code embodied in the medium. Computer program code for carrying out operations of the present invention may operate on any or all of the “server,” “computing device,” “computer device,” or “system” discussed herein. Computer program code for carrying out operations of the present invention may be written in any combination of one or more programming languages, including an object-oriented programming language such as Java, Smalltalk, C++, or the like, conventional procedural programming languages, such as Visual Basic, “C,” or similar programming languages. After-arising programming languages are contemplated as well.

A “data structure,” as discussed within the context of this patent application and related patent applications refers to a computer-based storage unit allowing for the storage of single or multiple types of data. The data structure may take the form of any computer-based storage unit functioning at any level of an OSI model, including computer files, .csv files, matrixes, a linked-list, arrays, tree structures, objects, variables, text files, SQL-databases or database entries, packets, frames, or any presently existing or after-arising equivalent. The “data structure” for the purposes defined herein can actually be one or multiple computer-storage units transmitted sequentially or in parallel.

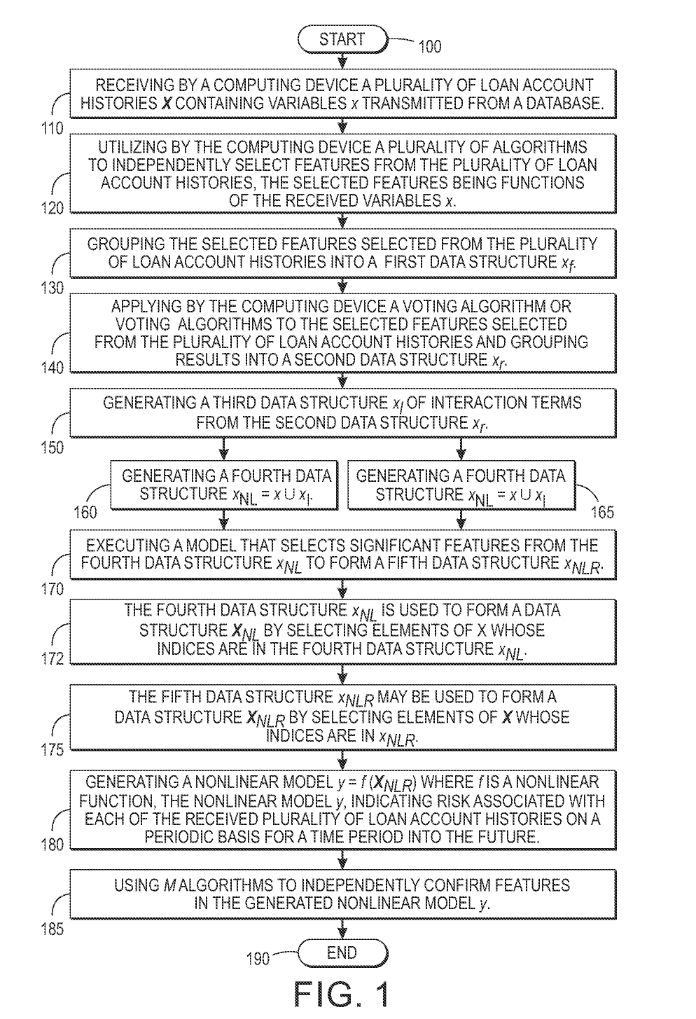

Referring to FIG. 1, displayed is a flowchart indicating the process of execution of an embodiment of the invention. In various embodiments of the invention, these steps are performed in any order, and/or only some of these steps are performed, and via a system, method, or apparatus. Execution begins at START 100. A computing device receives a plurality of loan account histories X containing variables x transmitted from a database 110. Variables may include loan behavior attributes such as loan status (ls) (e.g., current or not), delinquency days (dd), forbearance months (fin), loan age (la), principal balance outstanding (pbo), and number of on-time payments (notp), among others. Considering the large amount of data contained in thousands or more of loan accounts and associated loan account histories, a computerized database and computing device are required in order to process the data in a realistic period of time for use in the presently disclosed system, method, and apparatus. The loan account history data are heteroscedastic or homoscedastic as both types of data are processed by the presently disclosed invention. In the context of this disclosure, bold capital italic letters (e.g., X) refer to multi-dimensional arrays containing loan account data; lowercase italic letters (e.g., x) refer to real or integer numbers and sets thereof. Integer numbers are sometimes used to index portions of multi-dimensional arrays. For example, X(*, x) denotes the array comprising columns of X indexed by x; and similarly, X(x,*) denotes the array comprising rows of X indexed by x. In an embodiment of the invention, data from loan account histories is input as a set of variables XεR^{n×m} (where n is the number of loan accounts and m is the number of variables or features used to describe loan risk behavior) from the current month (Mc) up to j months back (Mc−j), where jεZ (integer numbers). At step 120, each of a plurality of algorithms independently selects features from the plurality of loan account histories, the selected features being functions of the received variables x. Each algorithm iεN (where N is the number of algorithms), selects features x_{fi} εR^{mi} from the plurality of loan accounts, where mᵢ≦m. In one embodiment of the invention, x_{fi} contains indices to a subset of features originally present in X. Note that each algorithm i may be run sequentially (i.e., one after the other) or in parallel (i.e., simultaneously). In the context of this disclosure, referral to algorithms as being independently performed describes this flexibility. In various embodiments of the invention there are between two or more of the following algorithms utilized which include some or all of an Elastic Net Algorithm, a LASSO Algorithm, a Stepwise Regression with the RIC Penalty Algorithm, and a Multivariate Adaptive Regression Splines Algorithm.

At step 130, selected features selected from the plurality of loan account histories are grouped into a first data structure x_{f}. In one embodiment of the invention, the first data structure is implemented as or to include a vector x_{f}=[x_{f1} . . . x_{fN}]. Features whose indices appear more frequently in x_{f} are more representative of the risk associated with the set of loan accounts X. In one embodiment of the invention, x_{f} contains all the indices of the features present in X selected by the algorithms.

At step 140 a voting algorithm or voting algorithms are applied to the selected features selected from the plurality of loan account histories and the results are grouped into a second data structure xᵣ. In an embodiment of the invention, as previously, the second data structure xᵣ is generated from vector x_{f} and a subset of feature indices xᵣ is created, containing indices to the features whose index appears at least r times in vector x_{f}. In a further embodiment of the invention, r is defined previously by default or by a user as between 1 and a fraction of N (e.g., the nearest integer to 20, 30, 40 or 50% of IV). Other embodiments may increase this further or change the value of r. Increasing r, while decreasing accuracy, does improve processing time. In yet a further embodiment of the invention the voting algorithm or algorithms include (1) selecting variables such that they have appeared r times pairwise in the first data structure X_{f′}, (2) selecting variables such that they appear r times in models that have a certain average accuracy; (3) selecting variables such that they appear r times pairwise; and (4) selecting variables such that occurrence in models with higher weightage (because of model type, efficiency, etc.) are included. The voting algorithm or algorithms produce a subset of features that will be used as potential individual (linear) and interaction (nonlinear) terms during the derivation of a nonlinear model. The voting algorithm or algorithms also function to select the more statistically significant selected features as selected by multiple algorithms.

The second data structure xᵣ may be used to form a data structure Xᵣ that is, in turn, used to generate a linear model, the linear model indicating risk associated with each of the received plurality of loan account histories on a periodic basis for a time period into the future. The linear model may be defined by an equation z=g(Xᵣ). The data structure Xᵣ may be formed by selecting all the elements of X whose indices are in xᵣ (such as, for example, all the elements in the columns of X whose column indices are in xᵣ).

At step 150, a third data structure x_{I} of interaction terms is generated from the second data structure xᵣ by the computing device. As previously, in some embodiments of the invention the third data structure x_{I} takes the form of a vector or any sort of computer-implemented structure. The “interaction terms” are, in some embodiments, a vector of all possible combinations of elements in xᵣ. In further embodiments of the invention, interaction terms comprise sets of two elements and sets of three elements in xᵣ. For example, let x_{I} denote the set of all the interaction terms formed from all the elements from the set xᵣ. For example, if xᵣ=[1 3 8] and the interaction terms comprise sets of two elements of xᵣ, then x_{I}=[(1,3) (1,8) (3,8) (1,1) (3,3) (8,8)].

Optionally, after step 150 execution proceeds to step 160 or step 165. At step 160, a fourth data structure x_{NL} is generated using the formula x_{NL}=xᵣ∪x_{I}. The mathematical “∪” (or “union”) operator has the typical meaning one of skill in the art would assign to it, specifically the meaning associated with the mathematical union operator. Optionally, execution may proceed from step 150 to 165 where the fourth data structure is generated with a new feature set x_{NL}=x∪x_{I}, containing all the original features in X, plus interaction terms between features selected by the voting stage with a potentially different value of r. The fourth data structure x_{NL}, as previously, may take the form of a vector in some embodiments of the invention or any sort of computer-implemented structure.

In an embodiment of the invention, the new feature set x_{NL}=xᵣ∪x_{I}, is used to create a new data structure X_{NL}. X_{NL} is, in turn, input to a nonlinear model that will further seek to reduce the set of features x_{NLR} contained in x_{NL} and produce a reduced set of features x_{NLR}, whose use in predictive tasks result in a better performance than the selection of features as discussed in connection with step 120. The new data structure X_{NL} is formed by X(*, x_{NL}), or equivalently by X(*, xᵣ) U X(*, x_{I}). X_{NL} may also be formed by X∪X(*, x_{I}). Since x_{I} contains indices denoting interaction terms, X(*, x_{I}) consists of columns containing the element-wise product between the columns indexed by the elements of x_{I}. For example, if x_{I}=[(1,3) (1,8) (3,8) (1,1) (3,3) (8,8)], then a column of X(*, x_{I}) comprises the element-wise multiplication between columns 1 and 3 of X, another comprises the element-wise multiplication between columns 1 and 8 of X, and so on.

In a further embodiment of the invention, the heteroscedasticity score of x_{NL} may be calculated. This process discussed in J. R. Schott, “A Test for the Equality of Covariance Matrices when the Dimension is Large Relative to the Sample Sizes,” JOURNAL COMPUTATIONAL STATISTICS & DATA ANALYSIS, 2007, p. 6535-6542, Vol. 51, Issue 2, Elsevier, Bridgewater, N.J. This publication is incorporated by reference here. If the calculated heteroscedasticity score is 1.7 or greater this indicates the presence of heteroscedasticity. In practice, different thresholds may be used to determine heteroscedasticity. In such circumstances, a weight

$$w ( k ) = \frac{1}{y ( k )} , y ( k ) > 0$$

for every k, may be defined, to minimize

$${r}^{T} r = \frac{y - \hat{y}}{y}$$

instead of e^{T}e=y−ŷ, to account for the heteroscedastic data. This is further discussed in C. Tofallis, “Least Squares Percentage Regression,” JOURNAL OF MODERN APPLIED STATISTICAL METHODS, 2008, p. 526-534, Vol. 7, Issue 2, Wayne State, Detroit, Mich. Note that r^{T} denotes the transpose of r and ŷ the estimated risk value output by the model.

At step 170, a model executes that selects significant features from the fourth data structure x_{NL} to form a fifth data structure x_{NLR}. In an embodiment of the invention, x_{NL} may be further reduced to generate a new feature set x_{NLR}; that is, feature selection algorithms may be executed on the features indicated by x_{NL}, which, it should be noted, may contain interaction terms. In an embodiment of the invention, a single model selects significant features via operation in a simultaneous or sequential fashion. In an alternate embodiment of the invention, a plurality of models is executed to select significant features.

At step 172, the fourth data structure x_{NL} is used to form X_{NL} by selecting elements of X whose indices are in the fourth data structure x_{NL}. At step 175, the fifth data structure x_{NLR} may be used to form a data structure X_{NLR} by selecting elements of X whose indices are in x_{NLR}.

As execution proceeds to step 180 a nonlinear model y=f (X_{NLR}) is generated. In an embodiment of the invention, X_{NLR} is a subset of X_{NL}. f is a nonlinear function, the nonlinear model y indicating risk associated with each of the received plurality of loan account histories on a periodic basis for a time period into the future. X_{NLR} is formed by X(*, x_{NLR}). The result is a low-dimensional nonlinear model with high accuracy. In an embodiment of the invention, risk is indicated via output of risk factors yεRⁿ assigned to all bank accounts i months ahead (Mc+j) from the current month. Let y(k)εR denote the risk factor assigned to bank account k. The data structure X_{NLR} may be formed by selecting elements in X (via review of the columns of X or other means) whose indices are in x_{NLR}. The generated nonlinear model y is stored in a non-transitory computer-readable storage medium for future use with test data.

In a further embodiment of the invention at step 180, a computation of risk associated with each bank account is performed based upon the value of three variables at month Mc+j: loan status (ls), delinquency days (dd), and forbearance months (fm). Other variables may be used in further embodiments. In various embodiments the computation of risk values or risk intervals associated with each bank account is performed by inspection of the set x. Generation of rules to assign risk values or risk intervals may be performed via standard logic, fuzzy logic, or even via an expert carrying out an inspection of the accounts themselves previous to later calculations by the computing device as discussed herein. The time period into the future for which risk is calculated for the plurality of loan accounts may be one week, one month, two months, six months, one year, or any other time period.

At step 185, M algorithms independently confirm features in the generated nonlinear model y. The M algorithms utilized may be, for example, an Elastic Net algorithm, a LASSO algorithm, a Stepwise Regression with the RIC penalty algorithm, and a Multivariate Adaptive Regression Splines Algorithm. At step 190, execution terminates in an embodiment of the invention. Other embodiments of the invention allow for returning to start 100 in order to perform further calculations by the computing device.

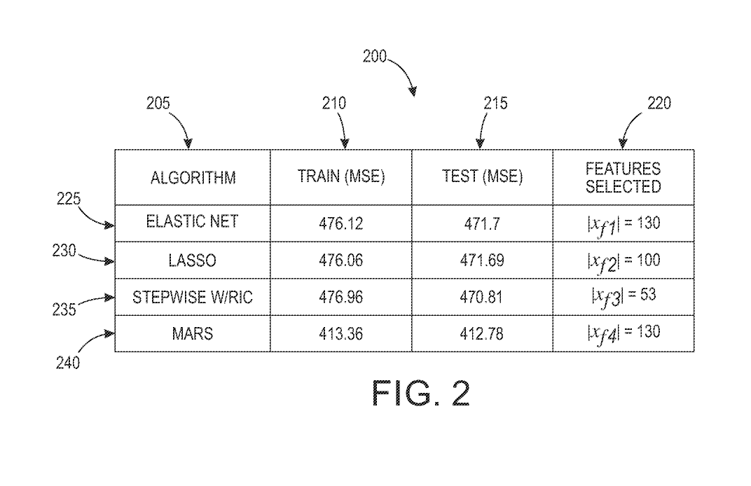

Referring to FIG. 2, displayed is a chart 200 showing the results of use of a plurality of algorithms to independently select features from a plurality of loan account histories in an exemplary embodiment of the invention. In this exemplary embodiment, previous to selection of features from the plurality of loan account histories, loan account history data is collected in a database from n=197,125 loan accounts that have m=332 variables. The loan account history data is split into XₜᵣₐᵢₙεR^{137,987×332}, YₜᵣₐᵢₙεR^{137,987×1} (70%), XₜₑₛₜεR^{59,138×332}, YₜₑₛₜεR^{59,138×332} (30%). In an embodiment of the invention, this data from loan account histories is for a time-frame 12 months in the past and the output will be computed 6 months in the future (i.e., the risk of defaulting up to 6 months in the future). “Algorithm” column 205 displays the name of the algorithm being used. The “Train (MSE),” Mean Squared Error between yₜᵣₐᵢₙ and ŷₜᵣₐᵢₙ, column 210 displays the results of application of the named algorithm to “Train” data. The “Test (MSE),” Mean Squared Error between yₜₑₛₜ and ŷₜₑₛₜ, column 215 displays the results of application of the named algorithm to “test” data. The “Features Selected” column 220 displays the number of features selected from the loan account history data, after independent selection of the data. “Features” refers to a subset of variables (dimensional reduction) obtained from the original set x that results in good prediction of the output (statistically significant), without over-fitting. The “Elastic Net” row 225 displays the results of application of the linear Elastic Net Algorithm. The “LASSO” row 230 displays the results of the application of the linear LASSO Algorithm. The “Stepwise w/RIC” row 235 displays the results of the application of the Stepwise with the Risk Inflation Criterion (RIC) Algorithm. The “MARS” row 240 displays the results of application of the Multivariate Adaptive Regression Splines (MARS) Algorithm. The MARS Algorithm is not linear but instead uses self-interaction terms. The Elastic Net Algorithm is discussed in H. Zou and Trevor Hastie, “Regularization and Variable Selection via the Elastic Net,” J. R. STATIST. SOC. B, 2005, p. 301-320, Vol. 67, Issue 2, Royal Statistical Society, London, England, the entirety of which is incorporated here. The LASSO Algorithm is discussed in R. Tibshirani, “Regression Shrinkage and Selection via the Lasso,” JOURNAL OF THE ROYAL STATISTICAL SOCIETY, 1996, p. 267-288, Vol. 58, Issue 1, Royal Statistical Society, London, England, the entirety of which is incorporated herein. D. Foster, et al., “Risk Inflation of Sequential Tests Controlled by Alpha Investing,” (unpublished article), The Wharton School of the University of Pennsylvania, Aug. 1, 2013, p. 1-19, available at http://www-stat.wharton.upenn.edu/˜stine/research/seq_risk.pdf (last visited Oct. 15, 2013), Philadelphia, Pa., the entirety of which is also adopted here.

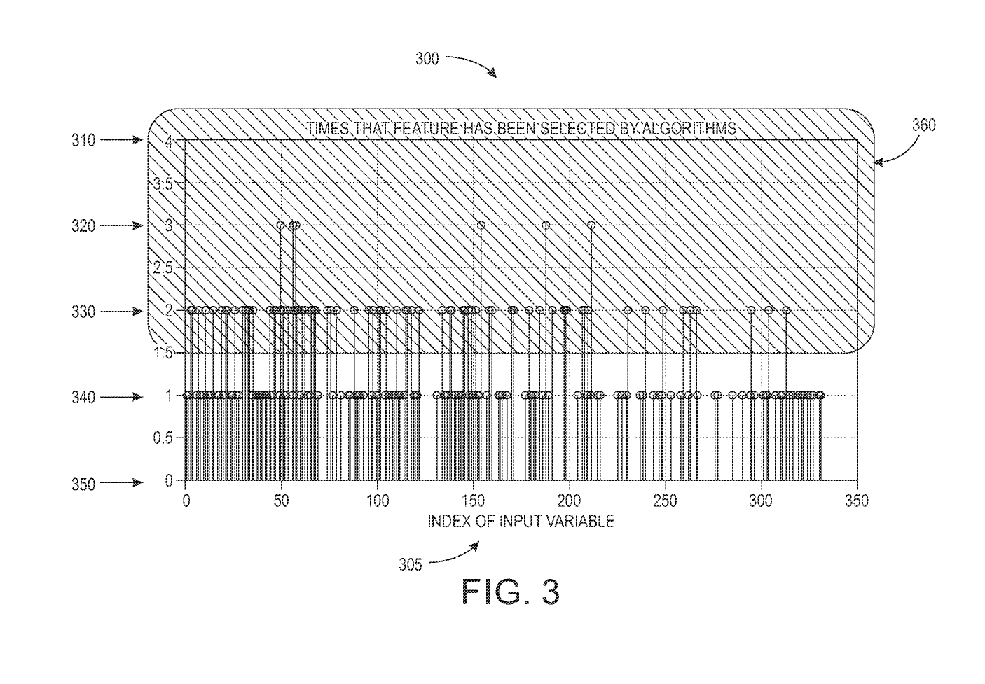

Referring to FIG. 3, displayed is a bar graph 300 showing the results of application of a voting algorithm to a data structure x_{f} in an embodiment of the invention. After formation of data structure x_{f} (such as discussed in connection with FIG. 1), in this embodiment only features that have appeared at least r=2 times are utilized to generate data structure xᵣ. FIG. 3 displays all features selected by a voting algorithm zero, once, twice, three, or four times. X-axis 305 displays the index number of the input variables ranging from 1 to 350 in this embodiment. The “index number” of the variable refers to the location of the variable. Y-axis 310 displays all features which have been selected exactly four times. Y-axis 320 displays all features which have been selected three times by the algorithms. Y-axis 330 displays all features which have been selected twice. Y-axis 340 displays all features which have been selected once. Y-axis 350 displays all features which have been selected zero times by the algorithm. In other embodiments of the invention, other values of r may be chosen, including between one and the number of the plurality of algorithms selected by the user. Note that the data bar graph 300 is based on is generated from execution of multiple algorithms to select features from the plurality of loan account histories, 187 out of 332 features are chosen by one algorithm, 75 out of 332 features are common to two algorithms, 7 out of 332 features are common to three algorithms, and only 1 feature is common to all algorithms. The shaded area 360 indicates the independent variables that will be selected (when r=2, as in the present embodiment). In an embodiment of the invention, as mentioned previously, data structure xᵣ will result.

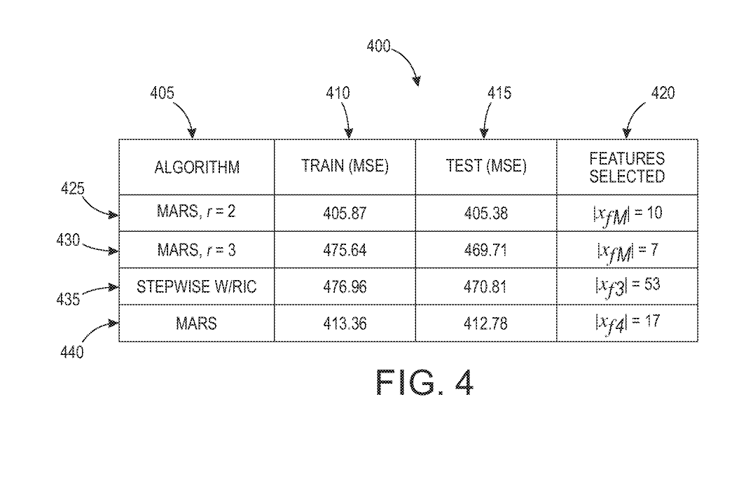

Referring to FIG. 4, displayed is a chart 400 showing training of a nonlinear model in an embodiment of the invention. Column 405 displays the algorithm utilized. Column 410 displays the Train (MSE) data. Column 415 the Test (MSE) data. Column 420 displays the numbers of features selected. As an initial example (not displayed), if r=1 in the presently disclosed embodiment |xᵣ|′=187, |x_{I}|=17,391, and |x_{NL}|=17,578. The notation |xᵣ| means the total number of indices contained in the data structure xᵣ. This approach is very computationally expensive due to all the combinations that the model utilizes during training, but it is still more computationally efficient than the case where all the interactions (i.e. 54,946) are considered from the original data (i.e. 332 variable). In an example displayed as row 425, r=2 is utilized, which results in |x_{NL}|=2,850 variables, approximately 5% of the available factors from the original loan account history data. The example displayed as row 430, r=3 is utilized, which results in |x_{NL}|=28 (i.e. 0.05% of the original variables). Row 435 displays results of the use of the Stepwise w/RIC algorithm. Row 440 displays results of the use of the MARS algorithm.

The preceding description has been presented only to illustrate and describe the invention. It is not intended to be exhaustive or to limit the invention to any precise form disclosed. Many modifications and variations are possible in light of the above teachings.

The preferred embodiments were chosen and described in order to best explain the principles of the invention and its practical application. The preceding description is intended to enable others skilled in the art to best utilize the invention in its various embodiments and with various modifications as are suited to the particular use contemplated. It is intended that the scope of the invention be defined by the following claims.

The invention described herein is to be construed in a manner consistent with all relevant local, municipal, federal, and international laws and is not intended to be violate the law in any way.

What is claimed is:

1. A method for loan risk prediction comprising:
Receiving by a computing device a plurality of loan account histories X containing variables x transmitted from a database;
Utilizing by said computing device a plurality of algorithms to independently select features from said plurality of loan account histories, the selected features being functions of the received variables x;
Grouping said selected features selected from said plurality of loan account histories into a first data structure x_{f};
Applying by said computing device a voting algorithm or voting algorithms to said selected features selected from said plurality of loan account histories and grouping results into a second data structure xᵣ; and
Generating by the computing device a third data structure x, of interaction terms from the second data structure xᵣ.

2. The method of claim 1 further comprising after generating by the computing device the third data structure x_{I}, then generating by the computing device a fourth data structure x_{NL} wherein x_{NL} equals selectively one of xᵣ∪x_{I} and x∪x_{I}.

3. The method of claim 2 further comprising after generating by the computing device the fourth data structure x_{NL} then executing a model that selects significant features from the fourth data structure x_{NL} to form a fifth data structure x_{NLR}.

4. The method of claim 3 wherein the fourth data structure x_{NL}, is used to form a data structure X_{NL} by selecting elements of X whose indices are in the fourth data structure x_{NL}.

5. The method of claim 3 wherein the fifth data structure X_{NLR}, is used to form a data structure X_{NLR} by selecting elements of X whose indices are in x_{NLR}.

6. The method of claim 5 further comprising generating a nonlinear model y=f(X_{NLR}), where f is a nonlinear function, the nonlinear model y indicating risk associated with each of said received plurality of loan account histories on a periodic basis for a time period into the future.

7. The method of claim 1 wherein the second data structure xᵣ is used by the computing device to form a data structure Xᵣ said data structure Xᵣ used to generate a linear model, the linear model indicating risk associated with each of said received plurality of loan account histories on a periodic basis for a time period into the future.

8. The method of claim 7 wherein the linear model is defined by an equation, z=g(Xᵣ).

9. The method of claim 7 wherein the data structure Xᵣ is formed by selecting elements of X whose indices are in xᵣ.

10. The method of claim 1 wherein the voting algorithm or voting algorithms applied to said selected features selected from said plurality of loan account histories to create a second data structure xᵣ perform the further steps of selectively one or more of the following a.-c.:
a. Selecting variables that appear at least r times in the first data structure x_{f};
b. Selecting variables that appear r times pairwise; and
c. Selecting variables that appear r times in models that have a certain average accuracy.

11. The method of claim 6 further comprising after generating the nonlinear model y, then using M algorithms to independently confirm features in the generated nonlinear model y.

12. The method of claim 1 wherein said plurality of algorithms selects features from said plurality of loan account histories by operating in parallel.

13. The method of claim 1 wherein said plurality of algorithms selects features from said plurality of loan account histories by operating sequentially.

14. The method of claim 1 wherein said plurality of algorithm(s) comprise selectively two or more of the following: an Elastic Net Algorithm, a LASSO Algorithm, a Stepwise Regression with the MC Penalty Algorithm, and a Multivariate Adaptive Regression Splines Algorithm.

15. The method of claim 6 wherein the generated nonlinear model y is stored in a non-transitory computer-readable storage medium for future use with test data.

16. The method of claim 6 wherein the time period into the future is selectively one of: one week, one month, two months, six months, and one year.

17. The method of claim 11 wherein said M algorithm(s) comprises selectively one or more of the following: an Elastic Net algorithm, a LASSO Algorithm, a Stepwise Regression with the RIC Penalty Algorithm, and a Multivariate Adaptive Regression Splines Algorithm.

18. The method of claim 1 wherein the third data structure x_{I} of interaction terms comprises sets of two elements and sets of three elements.

19. A system for loan risk prediction comprising:
A computing device performing the steps of:
Receiving a plurality of loan account histories X containing variables x transmitted from a database;
Utilizing a plurality of algorithms to independently select features from said plurality of loan account histories, the selected features being functions of the received variables x;
Grouping said selected features selected from said plurality of loan account histories into a first data structure x_{f};
Applying a voting algorithm or voting algorithms to said selected features selected from said plurality of loan account histories and grouping results into a second data structure xᵣ; and
Generating by the computing device a third data structure x_{I} of interaction terms from the second data structure xᵣ.

20. The system of claim 19 further comprising after generating by the computing device the third data structure x_{I}, then generating by the computing device a fourth data structure x_{NL} wherein x_{NL} equals selectively one of xᵣ∪x_{I} and x∪x_{I}.

21. The system of claim 20 further comprising after generating by the computing device the fourth data structure x_{NL}, then executing a model that selects significant features from the fourth data structure x_{NL} to form a fifth data structure x_{NLR}.

22. The system of claim 20 wherein the fourth data structure x_{NL} is used to form a data structure X_{NL} by selecting elements of X whose indices are in the fourth data structure X_{NL}.

23. The system of claim 21 wherein the fifth data structure x_{NLR} is used to form a data structure X_{NLR} by selecting elements of X whose indices are in x_{NLR}.

24. The system of claim 23 further comprising generating a nonlinear model y=f(X_{NLR}), where f is a nonlinear function, the nonlinear model y indicating risk associated with each of said received plurality of loan account histories on a periodic basis for a time period into the future.

25. The system of claim 19 wherein the second data structure xᵣ is used to form a data structure Xᵣ, said data structure Xᵣ used to generate a linear model, the linear model indicating risk associated with each of said received plurality of loan account histories on a periodic basis for a time period into the future.

26. The system of claim 25 wherein the data structure Xᵣ is composed by selecting elements of X whose indices are in xᵣ.

27. The system of claim 25 wherein the linear model is defined by an equation, z=g(Xᵣ).

28. The system of claim 19 wherein the voting algorithm or voting algorithms applied to said selected features selected from said plurality of loan account histories to create a second data structure xᵣ perform the further steps of selectively one or more of the following a.-c.:
a. Selecting variables that appear at least r times in the first data structure x_{f};
b. Selecting variables that appear r times pairwise; and
c. Selecting variables that appear r times in models that have a certain average accuracy.

29. The system of claim 24 further comprising after generating the nonlinear model y, then using M algorithms to independently confirm features in the generated nonlinear model y.

30. The system of claim 19 wherein said plurality of algorithms selects features from said plurality of loan account histories by operating in parallel.

31. The system of claim 19 wherein said plurality of algorithms selects features from said plurality of loan account histories by operating sequentially.

32. The system of claim 19 wherein said plurality of algorithms comprises selectively two or more of the following: an Elastic Net Algorithm, a LASSO Algorithm, a Stepwise Regression with the RIC Penalty Algorithm, and a Multivariate Adaptive Regression Splines Algorithm.

33. A method for loan risk prediction comprising:
Receiving by a computing device a plurality of loan account histories X containing variables x transmitted from a database;
Utilizing by said computing device a plurality of algorithms to independently select features from said plurality of loan account histories, the selected features being functions of the received variables x;
Grouping said selected features selected from said plurality of loan account histories into a first data structure x_{f};
Applying by said computing device a voting algorithm or voting algorithms to said selected features selected from said plurality of loan account histories and grouping results into a second data structure xᵣ;
Generating by the computing device a third data structure x_{I} of interaction terms from the second data structure xᵣ;
Generating by the computing device a fourth data structure x_{NL} wherein x_{NL} equals selectively one of xᵣ∪x_{I} and x∪x_{I};
Generating by the computing device a data structure X_{NL} wherein X_{NL} is formed by selecting the elements in the columns of X whose features are also in the fourth data structure x_{NL};
Executing a model that selects significant features from the fourth data structure x_{NL}; and
Generating a nonlinear model y=f(X_{NLR}) where f is a nonlinear function, the nonlinear model y indicating risk associated with each of the received plurality of loan account histories on a monthly basis for a time period into the future.
